(19) United States
(12) Patent Application Publication
(10) Pub. No.: US 2009/0323793 A1
(43) Pub. Date: Dec. 31, 2009

(54) ESTIMATION AND CORRECTION OF INTEGRAL CARRIER FREQUENCY OFFSET

(75) Inventors: Yu-Wen (Evan) Chang, Fremont, CA (US); Suzan Fishel, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MediaPhy Corporation, San Jose, CA (US)

(21) Appl. No.: 12/113,782

(22) Filed: May 1, 2008

Related U.S. Application Data
(60) Provisional application No. 60/915,614, filed on May 2, 2007.

(51) Int. Cl. H04B 17/00

(52) U.S. Cl. 375/226

(57) ABSTRACT

Systems, methods, and devices are described for estimating and correcting an integral carrier frequency offset. A wireless signal is received, the signal including a reference symbol. A first set of difference measurements between pairs of a series of subcarriers of the received wireless signal may be calculated. A second set of difference measurements between pairs of a series of subcarriers of the reference symbol may be calculated. The second set of difference measurements is searched using the first set of difference measurements. The first set of difference measurements is correlated with the second set of difference measurements to estimate an integral carrier frequency offset.

### CROSS REFERENCES

This application claims priority from co-pending U.S. Provisional Patent Application No. 60/915,614, filed May 2, 2007, entitled “ESTIMATION AND CORRECTION OF INTEGRAL CARRIER FREQUENCY OFFSET” (Attorney Docket No. 025950-000500US), which is hereby incorporated by reference, as if set forth in full in this document, for all purposes.

### BACKGROUND

The present invention relates to wireless communications in general and, in particular, to estimating and correcting of a carrier frequency offset.

Orthogonal Frequency Division Multiplexing (“OFDM”) is a widely adopted signaling scheme for wireless communications, due at least in part to its robustness against the effects of multipath fading channel propagation. A basic concept of OFDM is to carry the modulated bit-streams on individual orthogonal subcarriers. This transmission technique is especially suited for mitigating the effect of the multipath fading channel that often occurs during mobile reception. However, a drawback of OFDM transport systems is their high sensitivity to frequency offset.

The frequency offset often occurs because of oscillator variations. For example, the orthogonal subcarriers signals are typically transmitted on both sides of certain agreed center frequency, f_{c}. However, a transmitter may not transmit the signal centered on f_{c}, but may instead transmit the signal centered on f_{c}+Δₜ (e.g., deviation because of tuning oscillator instabilities or other errors). Similarly, while a receiver may attempt to receive the signal at the agreed center frequency, f_{c}, the receiver may instead attempt to receive the signal centered on f_{c}+Δᵣ (e.g., deviation because of tuning oscillator instabilities or other errors). The frequency offset may also be caused by Doppler shifts induced by the channel.

For purposes of estimation and correction, the frequency offset is usually divided into an integral part, which is a multiple of the subcarrier spacing, and a fractional part, which is less than one half of the subcarrier spacing. Traditionally, the integral part of frequency offsets have been addressed by correlating known pilot symbols and a version of the received pilot symbol at the receiver. However, traditional methods and devices may have difficulties in estimating the integral frequency offset when there are adverse channel noise conditions. Therefore, it may be desirable to have novel devices and methods for estimating and correcting integral frequency offset, for example, when there are adverse channel noise conditions.

### SUMMARY

Systems, devices, processors, and methods are described for estimating and correcting an integral carrier frequency offset. A wireless signal is received, the signal including a reference symbol. A first set of difference measurements between pairs of a series of subcarriers of the received wireless signal may be calculated. Using the first set of difference measurements, a second set of difference measurements between pairs of a series of subcarriers for the reference symbol is searched. The first set of difference measurements is correlated with the second set of difference measurements to estimate an integral carrier frequency offset.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a wireless system configured according to various embodiments of the invention.

FIG. 2 is a block diagram of a receiver device configured according to various embodiments of the invention.

FIG. 3 is a representation of a range of subcarriers for an OFDM signal received according to various embodiments of the invention.

FIG. 4 is a block diagram of a carrier frequency offset estimation and correction unit configured according to various embodiments of the invention.

FIG. 5 is a flowchart illustrating a method of estimating an integral carrier frequency offset according to various embodiments of the invention.

FIG. 6 is a flowchart illustrating a method of estimating and correcting an integral carrier frequency offset according to various embodiments of the invention.

FIG. 7 is a flowchart illustrating an alternative method of estimating and correcting an integral carrier frequency offset according to various embodiments of the invention.

### DETAILED DESCRIPTION OF THE INVENTION

Systems, devices, processors, and methods are described for estimating and correcting an integer carrier frequency offset. For example, in one embodiment, a communications device receives a wireless signal, the signal including a reference symbol. The communications device calculates a first set of difference measurements between pairs of a series of subcarriers of the received wireless signal. The communications device also calculates a second set of difference measurements between pairs of a series of subcarriers of the reference symbol. Using the first set of difference measurements, the second set of difference measurements is searched. The first set of difference measurements is correlated with the second set of difference measurements to estimate an integral carrier frequency offset.

The following description provides example embodiments only, and is not intended to limit the scope, applicability, or configuration of the invention. Rather, the ensuing description of the embodiments will provide those skilled in the art with an enabling description for implementing embodiments of the invention. Various changes may be made in the function and arrangement of elements without departing from the spirit and scope of the invention.

Thus, various embodiments may omit, substitute, or add various procedures or components, as appropriate. For instance, it should be appreciated that in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner.

It should also be appreciated that the following systems, methods, and software may individually or collectively be components of a larger system, wherein other procedures may take precedence over or otherwise modify their application. Also, a number of steps may be required before, after, or concurrently with the following embodiments.

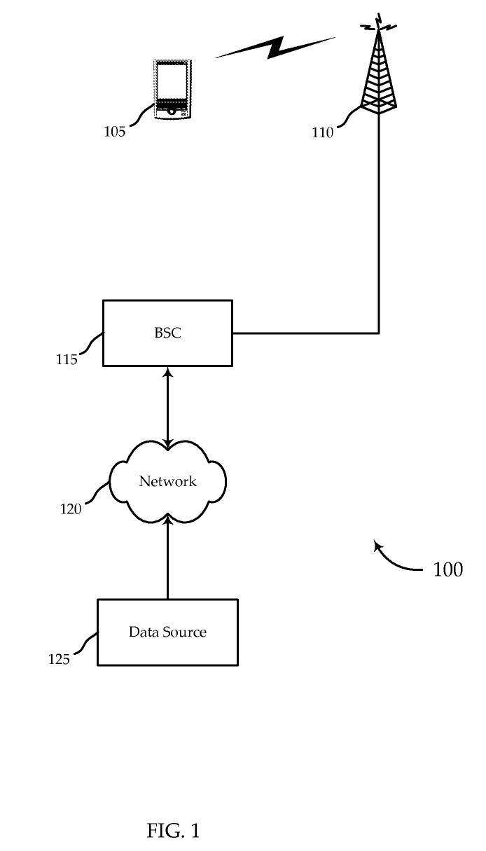

Novel techniques are described for the estimation and correction of an integral carrier frequency offset. Turning to FIG. 1, an example communications system 100 for implementing embodiments of the invention is illustrated. The system 100 includes a communications device 105. The communications device 105 may be a cellular telephone, other mobile phone, personal digital assistant (PDA), portable video player, portable multimedia player, portable DVD player, laptop personal computer, a television in transportation means (including cars, buses, and trains), portable game console, digital still camera or video camcorder, or other device configured to receive wireless communications signals.

In the illustrated embodiment, the device 105 communicates with one or more base stations 110, here depicted as a cellular tower. A base station 110 may be one of a collection of base stations utilized as part of a system 100 that communicates with the device using wireless signals. Thus, the communications device 105 may receive wireless signals from the base station 110, and utilize known information about the received signals to estimate and correct an integral carrier frequency offset according to embodiments of the invention.

The base station 110 is in communication with a Base Station Controller (BSC) 115 that routes the communication signals between the network and the base station 110. In other embodiments, other types of infrastructure network devices or sets of devices (e.g., servers or other computers) may also serve as an interface between a network 120 and the base station 110. For example, a BSC 115 may communicate with a Mobile Switching Center (MSC) that can be configured to operate as an interface between the device 105 and a Public Switched Telephone Network (PSTN).

The network 120 of the illustrated embodiment may be any type of network, and may include, for example, the Internet, an IP network, an intranet, a wide-area network (WAN), a local-area network (LAN), a virtual private network (VPN), the Public Switched Telephone Network (PSTN), or any other type of network supporting data communication between any devices described herein. A network 120 may include both wired and wireless connections, including optical links. The system 100 also includes a data source 125, which may be a server or other computer configured to transmit data (video, audio, or other data) to the communications device 105 via the network 120.

In one embodiment, at least a portion of the system 100 is an OFDM system. At the base station 110, the QAM symbols are modulated by means of an IFFT (inverse fast fourier transform) on N parallel subcarriers and the transmitted signal xₙ(m) can be expressed as follows:

$${x}_{n} ( m ) = {\sum }_{k = 0}^{N - 1} {X}_{n , k} {e}^{j2π m \frac{{kT}_{s}}{{T}_{s} N}} \qquad Eq . 1$$

where X_{n,k} represents the QAM symbol in the k^{th} subcarrier during the n^{th} symbol period, N and Tₛ represent the number of subcarriers and the duration of an OFDM symbol, respectively.

At the communications device, the received signal rₙ(m) can be expressed as:

$${r}_{n} ( m ) = {\sum }_{i = 0}^{L - 1} {x}_{n} ( m - {τ}_{i} ) {ρ}_{i} {e}^{\{ j2 π ( \frac{k}{{T}_{s}} + ɛ ) \frac{{T}_{s}}{N} m + {θ}_{i} \}} + w ( m ) \qquad Eq . 2$$

where L is the number of multipath, w(m) represents the additive white Gaussian noise (AWGN), ε is the frequency offset, ρᵢ, θᵢ, and τᵢ represent the amplitude attenuation, the phase shift and the relative delay corresponding to the i^{th} path, respectively. As mentioned earlier, the frequency offset ε is divided into an integral part fᵢ and a fractional part f_{f}, which can be expressed as:

ε=(⋄fᵢ+⋄f_{f})/Tₛ Eq. 3

In some embodiments of the invention, the communications device 105 is configured to estimate the integral carrier frequency offset of the received signal. The communications device 105 may correct for the estimated integral carrier frequency offset, as well. In other embodiments, the one or more of the steps for estimation of the integral carrier frequency offset for a received signal may be performed on a device other than the communications device 105 receiving the signal.

It is worth noting that aspects of the present invention may be applied to a variety of devices (such as communications device 105) generally and, more specifically, may be applied to mobile digital television (MDTV) devices. Aspects of the present invention may be applied to digital video broadcast standards that are either in effect or are at various stages of development. These may include the European standard DVB-H, the Japanese standard ISDB-T, the Korean standards digital audio broadcasting (DAB)-based Terrestrial-DMB and Satellite-DMB, the Chinese standards DTV-M, Terrestrial-Mobile Multimedia Broadcasting (T-MMB), Satellite and terrestrial interaction multimedia (STiMi), and the MediaFLO format proposed by Qualcomm Inc. While the present invention is described in the context of the DMB standard, it may also be implemented in any of the above or future standards, and as such is not limited to any one particular standard.

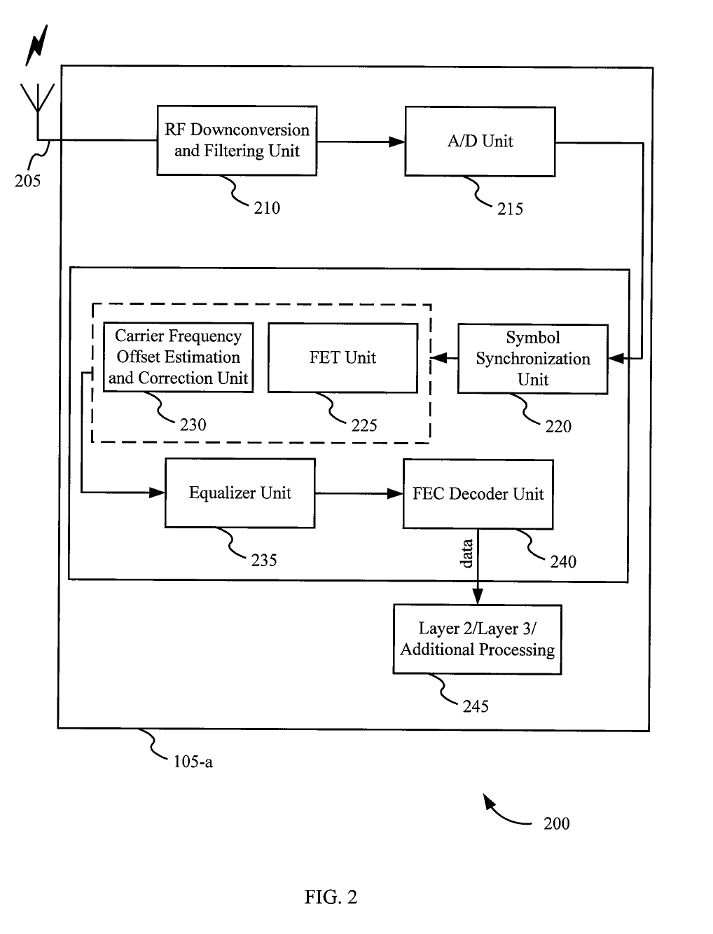

Referring to FIG. 2, an example block diagram 200 of a communications device 105-a is shown. The illustrated device 105-a may be the communications device 105 described with reference to FIG. 1. In the following embodiments, assume an orthogonal frequency division multiplexing (OFDM) system is implemented, while realizing that the principles described are applicable to a range of both wireless and wireline systems.

The device 105-a includes a number of receiver components, which may include: an RF down-conversion and filtering unit 210, A/D unit 215, symbol synchronization unit 220, FFT unit 225, carrier frequency offset estimation unit 230, equalizer unit 235, and FEC decoder unit 140. These units of the device may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

In one embodiment, the radio frequency signal is received via an antenna 205. The desired signal is selected and down-converted and filtered through the RF down-conversion and filtering unit 210. The output of that unit 210 is the analog baseband (or passband at much lower frequency than the original radio frequency) signal, which is converted into digital signal by the A/D unit 215. At the symbol synchronization unit 220, the signal is grouped into symbols with symbol boundary properly identified, and the guard periods are (typically cyclic prefix) removed. The processed signal is provided to FFT unit 225, where it is transformed to the frequency domain. At the carrier frequency offset estimation and correction unit 230, the frequency offset of the signal may be estimated and corrected. This correction may occur utilizing, in whole or in part, the process described in more detail below. The fractional carrier frequency offset is typically estimated and/or corrected (at least in part) before the integral frequency offset is measured and corrected. In different embodiments, the carrier frequency offset and symbol timing errors may be estimated and corrected before and/or after the FFT is performed.

The signal is then processed by the equalizer unit 235. With orthogonality, the sub-carriers do not interfere with each other, so a frequency-domain equalizer can be implemented separately for each sub-carrier (sometimes also called bin or carrier). Since the symbols are separated by some guard time period (cyclic prefix), the inter-symbol-interference (ISI) may be avoided.

The equalized signal may be forwarded to a FEC decoder unit 240, which may decode the signal and output a stream of data. This data stream may be forwarded to a layer 2/layer 3/additional processing unit 245 for further processing. It is worth noting that in one embodiment, the symbol synchronization unit 220, FFT unit 225, carrier frequency offset estimation unit 230, equalizer unit 235, and FEC decoder unit 240 are receiver components 255 implemented in a single PHY chip. It is also worth noting that in another embodiment, the RF down-conversion and filtering unit 210, A/D unit 215, symbol synchronization unit 220, FFT unit 225, carrier frequency offset estimation and correction unit 230, equalizer unit 235, and FEC decoder unit 240 are implemented in a single chip with RF and PHY functionality.

Returning to a discussion of the integral carrier frequency offset, consider an example wherein received symbols are demodulated using the FFT unit 225. Ignoring intersymbol interference (ISI) and AWGN terms at the receiver then, the received OFDM symbol for the k^{th} subcarrier can be written as:

Zₖ=X_{k-Δf}_{ᵢ}e^{j2π(k-⋄f}^{ᵢ}^{)τ/N} Eq. 4

where τ represents the symbol timing offset. Eq. 4 illustrates how the effect of the integral carrier frequency offset may correspond to a shift in the FFT by Δfᵢ compared with the original location. It further illustrates how the amount of a phase rotation of Zᵢ may be proportional to the product of k and τ.

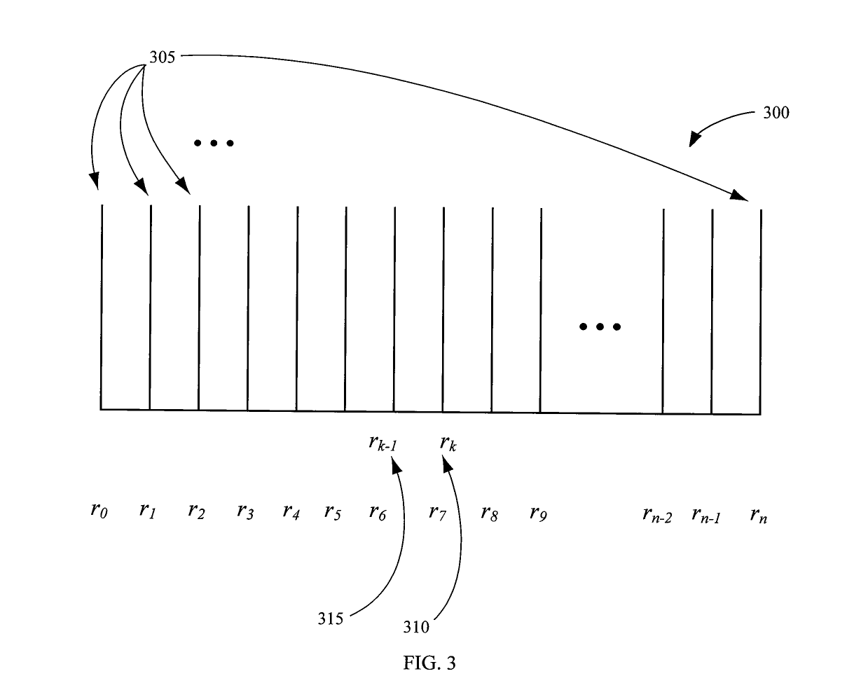

To further address these concepts, refer to FIG. 3, where a simplified frequency domain representation 300 of a number of adjacent subcarriers 305, r₀, r₁, . . . rₙ, is shown. These subcarriers 305 may be the subcarriers for an OFDM signal received according to the description relating to the device 105 of FIG. 1 or 2. For purposes of example, assume a simplification of aspects of Eq. 2. A received sample post FFT for subcarrier k at time n may be represented as r_{k,n}=H_{k,n}x_{k,n}, where H is the channel coefficient and x represents the original transmitted constellation. On the frequency direction, it may be assumed that the channel difference between two consecutive (or nearby) subcarriers <(H_{k,n}H*_{k-1,n})≅0. This is because the channel for each of two adjacent (or nearby) subcarriers will be very similar. Consider first the case of adjacent subcarriers, rₖ 310 and rₖ₋₁ 315. In this case, multiplying r_{k,n} by the conjugate of r_{k-1,n} provides a difference measurement of received signal at the pair of subcarriers. The following equation results:

r_{k,n}r*_{k-1,n}=H_{k,n}H*_{k-1,n}x_{k,n}x*_{k-1,n}≅x_{k,n}x*_{k-1,n} Eq. 5

Therefore, the likelihood that adjacent carriers have flat channel characteristics may be leveraged to effectively cancel the impact of the channel and retrieve x_{k,n} and the conjugate of x_{k-1,n}. This principle may be applied both to instances concerning adjacent subcarriers in the other frequency direction (e.g., r_{k,n}r*_{k+1,n}=H_{k,n}H*_{k+1,n}x_{k,n}x*_{k+1,n}≅x_{k,n}x*_{k+1,n}). This principle may also be applied in certain circumstances to nearby subcarriers (e.g., rₖ 310 with rₖ₋₂, or rₖ 310 with rₖ₊₃). While in one embodiment, therefore, the difference measurement between r_{k,n} and r_{k-1,n} may be calculated using r_{k,n}r*_{k-1,n}≅x_{k,n}x*_{k-1,n}, other difference measures may be used in other embodiments.

Returning to FIG. 2, consider an example wherein received symbols are demodulated using the FFT unit 225 and transformed to the frequency domain before at least part of the integral carrier frequency offset estimation and correction. Moreover, assume that the carrier frequency offset estimation and correction unit 230 knows a series of reference symbols that are to be received (e.g., known pilots). The known pilot may be referred to as φₙ in the original phase reference at subcarrier n value. A reference symbol may be any symbol which includes one or more pilots known at the receiving device 105-a; however, in some embodiments, a reference symbol is a symbol in which all of the subcarriers are known pilots. Also assume that one is trying to determine integral carrier frequency offset among a number of received carriers, and a set of sufficiently diverse pilots. In an example utilizing adjacent carriers, recall that r_{k,n}r*_{k-1,n}≅x_{k,n}x*_{k-1,n}. By correlating x_{k,n}x*_{k-1,n} with φ_{k,n}φ*_{k-1,n} (the difference measurement for φ_{k,n} and φ_{k-1,n}) among a number of adjacent subcarrier pairs for the known reference, an integral carrier offset may be determined. A number of different methods of correlation may be used, as evident to those skilled in the art.

In one embodiment, merely by way of example, the following method of correlation set forth generally with Eq. 6 and 7 may be used:

Zₖ₊ᵢ=sign(rₖ₊ᵢr*ₖ₊ᵢ₋₁)×φₖ₋₁φ*ₖ=zₙ₋₁¹zₖ₋₁₂

where, zₙ₋₁¹=sign(rₖ₊ᵢr*ₖ₊ᵢ₋₁) and, zₖ₋₁²=φₖ₋₁φ*ₖ Eq. 6

The integral carrier frequency offset may then be determined by finding the maximum correlation between the range of adjacent subcarriers at different offsets (a number of correlations are used in certain embodiments), as set forth below:

$$Δ f = arg {max}_{i ∈ S} \{ abs ( {\sum }_{k = 0}^{M - 2} {Z}_{k + i} ) \} \qquad Eq . 7$$

where Δf is an integer multiple of the carrier spacing, rₖ is the received subcarrier k value of the phase reference symbol, and φₖ is the original phase reference at subcarrier k value. The searching window in one embodiment is:

S=[−Sₘₐₓ,Sₘₐₓ], and Sₘₐₓ=(N−M)/2. Eq. 8

It is worth noting that the preceding equations illustrate one example only, and a number of variations may be used. As noted above, this type of correlation (utilizing the sign function) is but one example of the different methods of correlation that may be used. Also note that the correlations related to Eq. 6 may be between non-adjacent carriers (e.g., correlating x_{k,n}x*_{k+2,n} and φ_{k,n}φ*_{k+2,n}, or correlating x_{k,n}x*_{k-3,n} and φ_{k,n}φ*_{k-3,n}).

Also, instead of correlating all the pairs of subcarriers, only a subset may be correlated. For example, instead of correlating each adjacent pair for the entire FFT size, only a subset of the specified pairs of subcarriers is correlated. Similarly, instead of correlating across the entire spectrum of subcarriers, only part of the spectrum could be correlated. Moreover, the correlation may be directed at a particular part of the waveform (e.g., a part that has higher information content or diversity). The pilots also may be located in only a part of the waveform (with data in the remainder), and the correlations may be directed only at the pilots.

The sliding window range may be modified as well. For example, the frequency offset estimations and corrections may be monitored, and the sliding window width may be dynamically widened if the monitored integral carrier frequency offset expands, or if the variability of the integral carrier frequency offset is high. In contrast, the sliding window width may be dynamically narrowed if the monitored integral carrier frequency offset narrows, or if the integral carrier frequency offset is relatively stable. Also, the SNR or other signal quality metric of subcarriers may be monitored, and the correlations may be directed at the better pairs of carriers (e.g., the subcarrier pairs with better SNR or other signal quality metrics). Also, the determination on the number of correlations to be performed may be made dynamically (e.g., based on the correlations needed with a previous integral carrier frequency offset estimation, based on the time between estimations, based on the particular reference symbol, etc.).

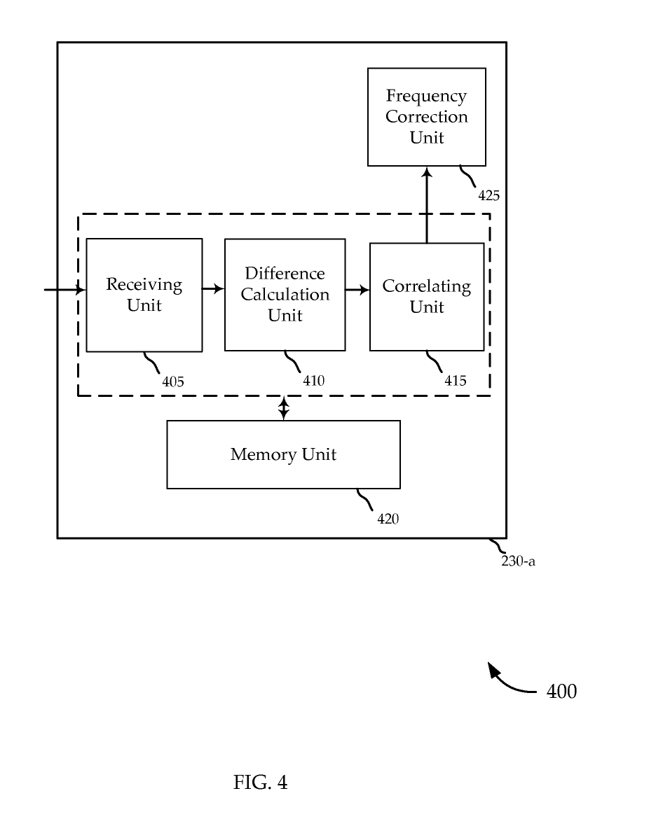

Turning to FIG. 4, a block diagram is shown illustrating an example configuration 400 of a carrier frequency offset estimation and correction unit 230-a that may estimate, and perhaps correct, the integral carrier frequency offset according to various embodiments of the invention. This unit 230-a of FIG. 4 may be the carrier frequency offset estimation and correction unit 230 of FIG. 2, implemented in the communications device 105 of FIG. 1. However, some or all of the functionality of this unit 230-a may be implemented in other devices.

The carrier frequency offset estimation and correction unit 230-a in the illustrated embodiment includes a receiving unit 405, a difference calculation unit 410, a correlating unit 415, a memory unit 420, and a frequency correction unit 425. These units of the device may, individually or collectively, be implemented with one or more Application Specific Integrated Circuits (ASICS) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiving unit 405 may receive the wireless signal including a reference symbol. This may, for example, be a digitized version of an OFDM signal sent according to the DMB standard. The received signal may, for example, be the frequency domain representation of the wireless signal, as output from the FFT unit 225 of FIG. 2. The received signal may then be stored in memory unit 420.

The difference calculation unit 410 may retrieve the signal stored in the memory unit 420, and calculate a set of difference measurements between pairs of a series of subcarriers of the received wireless signal. The series of subcarriers may be a series of adjacent subcarriers, and each pair for which a difference is measured may be a pair of adjacent subcarriers. Each difference measurement for the wireless signal may be a product of a first version of the received wireless signal at a one subcarrier and a second, conjugate version of the received wireless signal at a second subcarrier. The set of difference measurements for the wireless signal may be stored in the memory unit 420.

The difference calculation unit 410 may also retrieve the known subcarrier data (e.g., pilot data) of the reference symbol, which may also be stored in the memory unit 420. The difference calculation unit 410 may calculate a set of difference measurements between pairs of a series of subcarriers of the reference symbol. As above, the series of subcarriers may be a series of adjacent subcarriers, and each pair for which a difference is measured may be a pair of adjacent subcarriers. Each difference measurement for the reference symbol may be a product of a first version of the received wireless signal at a one subcarrier and a second, conjugate version of the received wireless signal at a second subcarrier. The set of difference measurements for the reference symbol may be stored in the memory unit 420 (either before or after the calculation and storage of the set of difference measurements for the wireless signal). The set of difference measurements for the reference symbol may be pre-computed and stored in memory, and need not be computed each time.

The correlating unit 415 may then retrieve the set of difference measurements for the wireless signal and the set of difference measurements for the reference symbol. The correlating unit 415 searches the set of difference measurements for the reference symbol using the set of difference measurements for the wireless signal. Based on the search, the correlating unit 415 correlates at least a subset of the difference measurements for the wireless signal with at least a subset of difference measurements for the reference symbol (e.g., as set forth via Eq. 6 and 7 and the discussion related thereto) to estimate an integral carrier frequency offset.

The searching window size (e.g., the searching window set forth via Eq. 8 and the discussion related thereto) may be set or modified based at least in part on a variability measure or a size of one or more previously estimated integral carrier frequency offsets. For example, if the estimated integral carrier frequency offsets vary substantially, the window size may be dynamically enlarged. However, if the estimated integral carrier frequency offset is stable, the window size may be dynamically enlarged. Similarly, if the size of an integral carrier frequency offset is large, the search window for subsequent searches may be widened. The search window may be narrowed if the estimated integral carrier frequency offset decreases. Other metrics may be used as well, as window size may be based on SNR or time between correlations (e.g., increasing window size as SNR decreases or time between correlations increases). The type of a particular receiver device type may also influence window size calculations.

Once the integral carrier frequency offset is estimated, the correlating unit 415 determination may be made whether the estimated integral carrier frequency offset exceeds a minimum confidence threshold. This confidence threshold may, for example, specify that the correlation attributed to the estimated offset exceed the correlations for other offsets by a given percentage. If the estimated offset fails to exceed the threshold, difference measurements for another received signal (e.g., later arriving signals) may be calculated. The correlating unit 415 may then correlate the new difference measurements with the difference measurements for the reference symbol to estimate a new integral carrier frequency offset. In one embodiment, the new difference measurements may be integrated with difference measurements of one or more previous wireless signals, and the integrated difference measurements may be correlated with the difference measurements for the reference symbol to estimate a new integral carrier frequency offset. In other embodiments, difference measurements from various received signals may be otherwise averaged or combined.

The estimated integral carrier frequency offset information may be forwarded to a frequency correction unit 425. In one embodiment, the offset information is forwarded only if the offset exceeds the confidence threshold. The frequency correction unit 425 may receive the integral carrier frequency offset information, and may correct the offset. This correction may be performed by transmitting a control signal to modify a center frequency to correct an estimated offset at the receiving device. In other embodiments, a receiver could serve as a reference terminal, and transmit certain correction information to a transmitter (or perhaps other receivers).

Once the estimated integral carrier frequency offset is corrected, the intervals between calculations (and, therefore, between correlations) may be set. These intervals may be set, for example, by the difference calculation unit 410 or the correlating unit 415. In one embodiment, the interval is set to occur at each burst for a video broadcasting standard. In another embodiment, the interval is set to occur only at startup or when there are errors. In other embodiments, the interval between each calculation and correlation is set based on a variability measure of recent integral carrier frequency offsets and the size of one or more previously estimated offset. As variability and size of the estimated integral carrier frequency offsets decreases, the interval between such calculations and correlations may decrease as well.

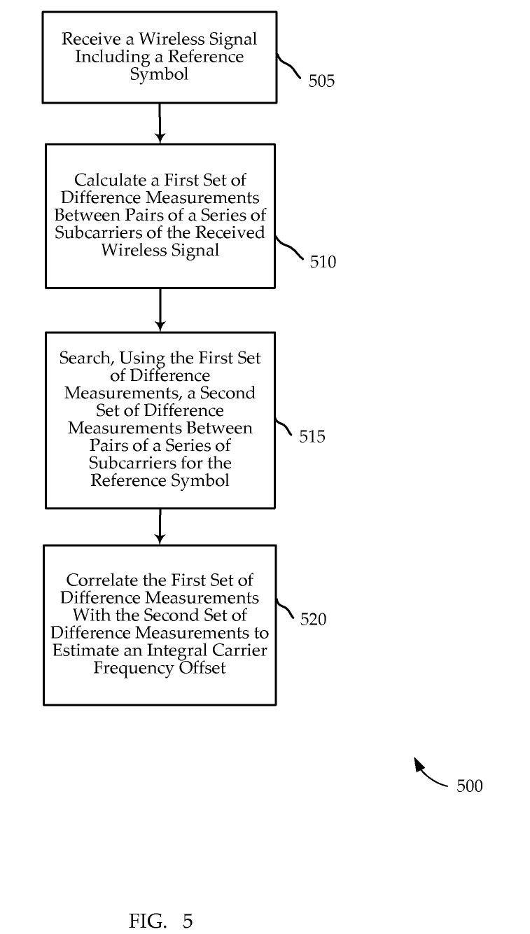

FIG. 5 is a flowchart illustrating a method 500 of estimating an integral carrier frequency offset according to various embodiments of the invention. The method 500 may, for example, be performed in whole or in part on the mobile communications device 105 of FIG. 1 or, more specifically, the carrier frequency offset estimation and correction unit 230 of FIG. 2 or 4.

At block 505, a wireless signal is received, the signal including a reference symbol. At block 510, a first set of difference measurements between pairs of a series of subcarriers of the received wireless signal is calculated. At block 515, using the first set of difference measurements, a second set of difference measurements between pairs of a series of subcarriers for the reference symbol is searched. At block 520, the first set of difference measurements is correlated with the second set of difference measurements to estimate an integral carrier frequency offset.

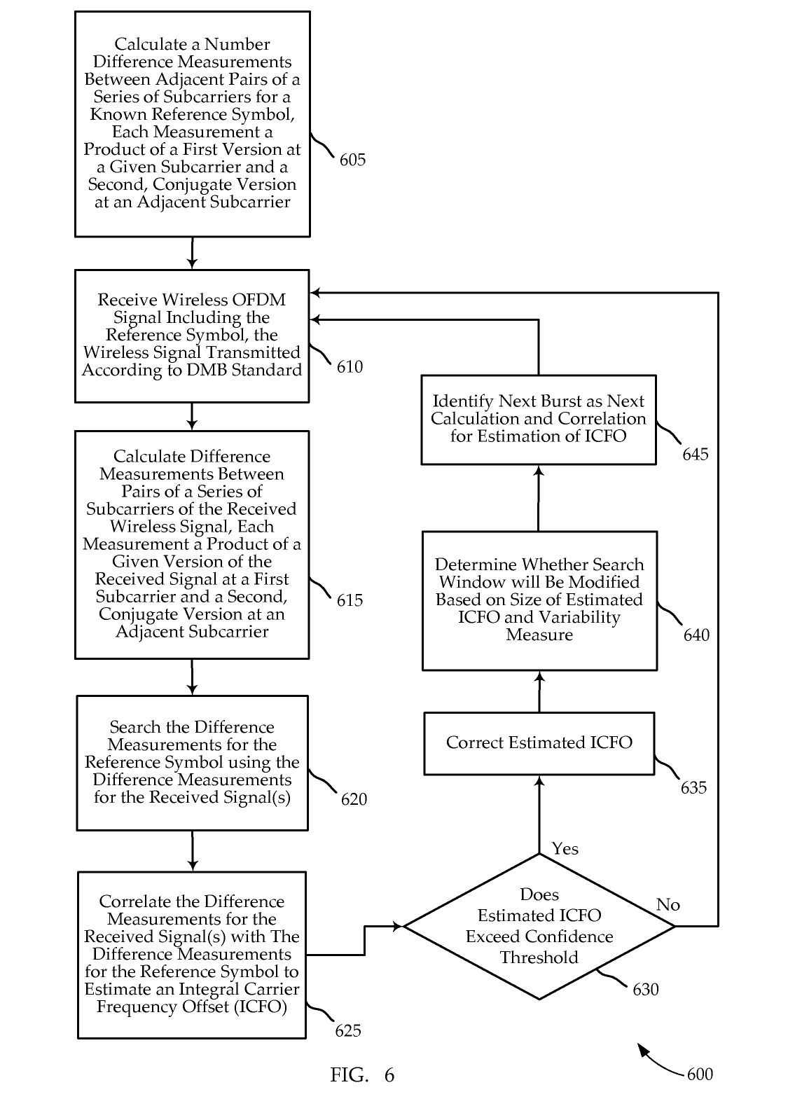

FIG. 6 is a flowchart illustrating a method 600 of estimating and correcting an integral carrier frequency offset according to various embodiments of the invention. The method 600 may, for example, be performed in whole or in part on the mobile communications device 105 of FIG. 1 or, more specifically, the carrier frequency offset estimation and correction unit 230 of FIG. 2 or 4.

At block 605, a number of difference measurements between adjacent pairs of a series of subcarriers is calculated for a known reference symbol, each measurement a product of a first version at a given subcarrier and a second, conjugate version at an adjacent subcarrier. In one embodiment, a given subcarrier may be used as a first version for one measurement, and be a conjugate version for another measurement. However, a subcarrier may in other embodiments only be used for a single measurement (instead of for two measurements). Also, in still other embodiments, pairs may be spaced between one or more subcarriers not included in the difference measurement calculations.

At block 610, a first wireless OFDM signal including the reference symbol is received, the wireless signal transmitted according to the DMB standard. At block 615, difference measurements between pairs of a series of subcarriers of the received wireless signal are calculated, each measurement a product of a given version of the received signal at a first subcarrier and a second, conjugate version at an adjacent subcarrier. As above, a given subcarrier may be a first version for one measurement, and be a conjugate version for another measurement. However, a subcarrier may in other embodiments be used for only a single measurement (instead of for two measurements). Also, in still other embodiments, pairs may be spaced between one or more subcarriers not included in the difference measurement calculations.

At block 620, the difference measurements for the reference symbol are searched using the difference measurements for the received signal. At block 625, the difference measurements for the received signal are correlated with the difference measurements for the reference symbol to estimate an integral carrier frequency offset (ICFO). At block 630, a determination is made whether the estimated ICFO exceeds the confidence threshold.

Assume first that the estimated ICFO exceeds the confidence threshold. If yes, at block 635, the estimated ICFO is corrected. At block 640, a determination is made whether a search window size for the search step will be modified, the determination based on the size of the estimated ICFO and a variability measure of one or more recent ICFO estimations. At block 645, the next burst is identified for the next calculation and correlation for estimation of ICFO.

However, if at block 630 a determination is made that the estimated ICFO fails to exceed the confidence threshold, the process may return to block 610, where a later arriving second wireless OFDM signal may be received. Again, at block 615, difference measurements between pairs of a series of subcarriers of the later arriving, second wireless signal are calculated, each measurement a product of a given version of the received signal at a first subcarrier and a second, conjugate version at an adjacent subcarrier. At block 620, the difference measurements for the reference symbol are searched using the difference measurements for the later arriving, second signal (this search may use the difference measurements for the second, later arriving wireless signal alone, or may integrate or otherwise combine them with the difference measurements for the first wireless signal (and/or perhaps other signals as well). At block 625, the search results are used to identify a second ICFO, and the loop returns to consideration of the confidence threshold at block 635.

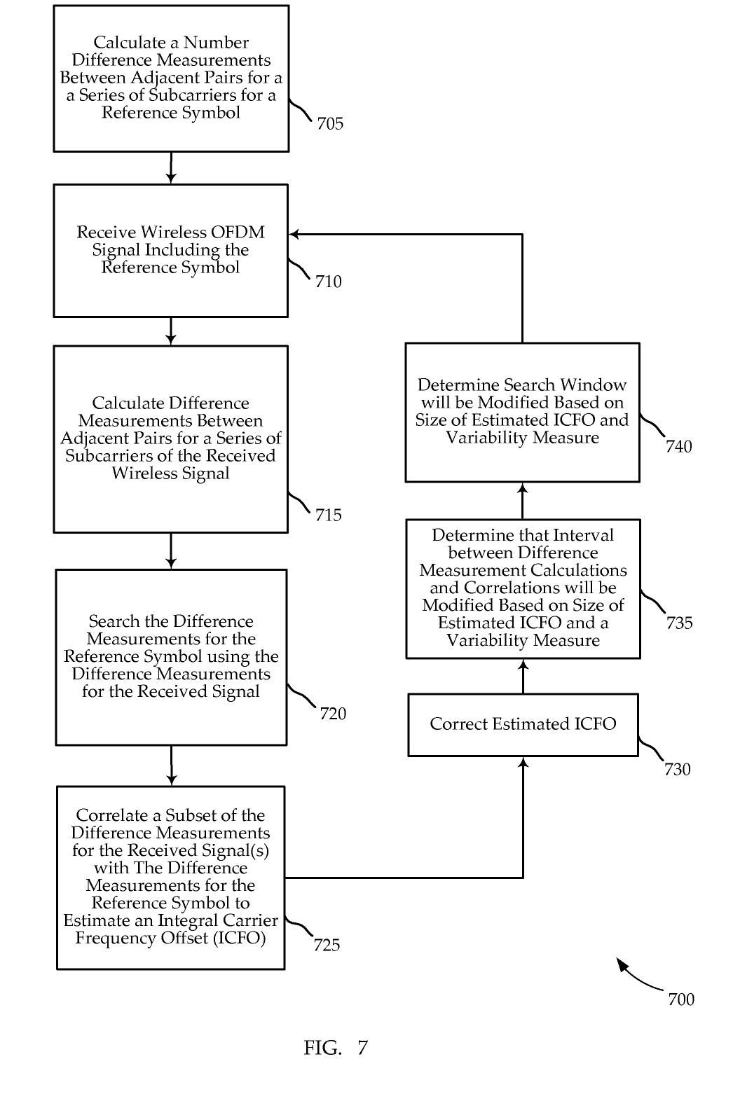

FIG. 7 is a flowchart illustrating an alternative method 700 of estimating and correcting an integral carrier frequency offset according to various embodiments of the invention. The method 700 may, for example, be performed in whole or in part on the mobile communications device 105 of FIG. 1 or, more specifically, the carrier frequency offset estimation and correction unit 230 of FIG. 2 or 4.

At block 705, a number of difference measurements between adjacent pairs for a subset of a series of subcarriers for a reference symbol is calculated. At block 710, a wireless signal is received, the signal including the reference symbol. At block 715, difference measurements are calculated between adjacent pairs in a series of subcarriers of the received wireless signal.

At block 720, the difference measurements for the reference symbol are searched using the difference measurements for the received signal. At block 725, at least a subset of the difference measurements for the received signal is correlated with the difference measurements for the reference symbol to estimate an integral carrier frequency offset (ICFO). At block 730, the estimated ICFO is corrected.

At block 735, a determination is made that the interval between difference measurement calculations and correlations will be modified, the determination based on the size of the estimated ICFO and a variability measure. At block 740, it is determined that a search window will be modified based on the size of the estimated ICFO and variability measure. The process may then return to block 710 for additional estimations.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method of signal processing to estimate an integral carrier frequency offset, the method comprising:
receiving a wireless signal at a receiver, the wireless signal including a reference symbol;
calculating a first set of difference measurements between pairs of a series of subcarriers of the received wireless signal;
searching, using the first set of difference measurements, a plurality of difference measurements between pairs of a series of subcarriers for the reference symbol; and
correlating the first set of difference measurements with a second set of difference measurements among the plurality of difference measurements to estimate a first integral carrier frequency offset.

2. The method of claim 1, wherein,
each series of subcarriers comprise a plurality of adjacent subcarriers; and
the received wireless signal comprises an orthogonal frequency-division multiplexing (OFDM) signal.

3. The method of claim 1, wherein each of the first set of difference measurements comprises a product of a first version of the received wireless signal at a first subcarrier and a second, conjugate version of the received wireless signal at a second subcarrier.

4. The method of claim 3, wherein,
each pair of the series for the first set of difference measurements are adjacent subcarriers; and
each pair of the series for the second set of difference measurements are adjacent subcarriers.

5. The method of claim 1, further comprising:
identifying a window size for the searching step based at least in part on a size of a previously estimated integral carrier frequency offset.

6. The method of claim 5, further comprising:
modifying the identified window size for a future search based on a variability measure and a size of the first integral carrier frequency offset.

7. The method of claim 1, further comprising:
determining whether the first integral carrier frequency offset exceeds a minimum confidence threshold.

8. The method of claim 7, further comprising:
calculating, when the first integral carrier frequency offset does not exceed the minimum confidence threshold, a third set of difference measurements for a later arriving signal;
integrating the first set of difference measurements and the third set of difference measurements to generate an average set of difference measurements; and
correlating the average set of difference measurements with the plurality of difference measurements to estimate a second integral carrier frequency offset.

9. The method of claim 1, further comprising:
modifying a center frequency for the receiver to correct an estimated offset based at least in part on the first integral carrier frequency offset.

10. The method of claim 1, further comprising:
transmitting data to a transmitter to modify a center frequency for the transmitter to correct for the first integral carrier frequency offset.

11. The method of claim 1, further comprising:
identifying an interval between the correlation of the first set of difference measurements and a later, second correlation, the interval based at least in part on a variability measure and a size of the first integral carrier frequency offset.

12. The method of claim 1, wherein for the reference symbol:
the receiver knows a first subset of the carriers for the reference symbol before the wireless signal is received;
the receiver does not know a second subset of the carriers for the reference symbol before the wireless signal is received; and
the first set of difference measurements comprises measurements of the first subset and not of the second subset.

13. A processor for estimating an integral carrier frequency offset, the processor configured to:
calculate a first set of difference measurements between pairs of a series of subcarriers of a wireless signal, the wireless signal comprising a known reference symbol;
search, using the first set of difference measurements, a plurality of difference measurements between pairs of a series of subcarriers for the known reference symbol; and
correlate the first set of difference measurements with a second set of difference measurements among the plurality of difference measurements to estimate an integral carrier frequency offset.

14. The processor of claim 13, further configured to:
determine that the first integral carrier frequency offset does not exceed a minimum confidence threshold;
calculate a third set of difference measurements for a later arriving signal; and
correlate the third set of difference measurements with the plurality of difference measurements to estimate a second integral carrier frequency offset.

15. A receiver device configured to determine an integral carrier frequency offset, the device comprising:
a receiving unit configured to receive a wireless signal including a reference symbol;
a difference calculation unit, communicatively coupled with the receiving unit, and configured to:
calculate a first set of difference measurements between pairs of a series of subcarriers of the received wireless signal;
calculate a plurality of difference measurements between pairs of a series of subcarriers for the reference symbol; and
a correlating unit, communicatively coupled with the difference calculation unit, and configured to:
search, using the first set of difference measurements, the plurality of difference measurements; and
correlate the first set of difference measurements with a second set of difference measurements among the plurality of difference measurements to estimate a first integral carrier frequency offset.

16. The device of claim 15, wherein,
each of the first set of difference measurements comprises a product of a first version of the received wireless signal at a first subcarrier and a second, conjugate version of the received wireless signal at a second, adjacent subcarrier; and
the received wireless signal comprises an orthogonal frequency-division multiplexing (OFDM) signal.

17. The device of claim 15, wherein the correlating unit is further configured to:
identify a window size for the searching step based at least in part on a variability measure and a size of a previously estimated integral carrier frequency offset.

18. The device of claim 15, wherein the correlating unit is further configured to:
determine that the first integral carrier frequency offset does not exceed a minimum confidence threshold; and
use a third set of difference measurements for a later arriving signal with the first set of difference measurements to estimate a second integral carrier frequency offset.

19. The device of claim 15, further comprising:
a frequency correction unit, communicatively coupled with the correlating unit, and configured to transmit a control signal to modify a center frequency to correct an estimated offset based at least in part on the first integral carrier frequency offset.

20. The device of claim 15, wherein,
the second set of difference measurements comprises the plurality of difference measurements; and
the plurality of difference measurements comprises each of the subcarriers of the reference symbol.

21. The device of claim 15, wherein the difference calculation unit is further configured to:
identify an interval between the calculation of the first set of difference measurements and a later, second calculation for purposes of a later, second correlation, the interval based at least in part on a variability measure associated with the first integral carrier frequency offset.

22. The device of claim 15, wherein,
the second set of difference measurements comprises the plurality of difference measurements;
the difference calculation unit is further configured to calculate difference measurements at the beginning of each burst; and
the correlating unit is further configured to correlate the calculated difference measurement from the beginning of each burst to estimate the integral carrier frequency offset.

23. A system to estimate an integral carrier frequency offset, the system comprising:
a base station unit configured to transmit an orthogonal frequency-division multiplexing (OFDM) wireless signal comprising a reference symbol; and
a receiver device, in wireless communication with the base station unit, and configured to:
receive the wireless signal;
calculate a first set of difference measurements between pairs of a series of subcarriers of the received wireless signal;
calculate a plurality of difference measurements between pairs of a series of subcarriers for the reference symbol; and
search the plurality of difference measurements using the first set of difference measurements; and
correlate the first set of difference measurements with a second set of difference measurements among the plurality of difference measurements to estimate an integral carrier frequency offset.

24. The system of claim 23, wherein,
the receiver device is further configured to correct the integral carrier frequency offset based on the received estimate; and
the receiver device comprises a mobile communications device.

25. A method of signal processing to estimate an integral carrier frequency offset, the method comprising,
calculating a first difference measurement between two subcarriers of a received wireless signal, the received wireless signal including a reference symbol known at a receiver;
searching a plurality of difference measurements between two subcarriers for the known reference symbols using the first difference measurement; and
correlating the first difference measurement with a second difference measurement among the plurality of difference measurements to thereby identify an integral carrier frequency offset.
